(19) United States
(12) Patent Application Publication
(10) Pub. No.: US 2023/0153651 A1
(43) Pub. Date: May 18, 2023

(54) ENTERPRISE MANAGEMENT SYSTEM AND EXECUTION METHOD THEREOF

(71) Applicants: Digiwin Software Co., Ltd, Shanghai (CN); DATA SYSTEMS CONSULTING CO., LTD., New Taipei City (TW)

(72) Inventors: Wenliang Bi, Shanghai (CN); Chih Wang, Shanghai (CN); Shih-Hung Liu, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 17/673,793

(22) Filed: Feb. 17, 2022

(30) Foreign Application Priority Data
Nov. 17, 2021 (CN) 202111365202.2

(51) Int. Cl. G06N 5/04; G06K 9/62; G06F 16/215

(52) U.S. Cl. CPC G06N 5/04; G06K 9/6256; G06F 16/215

(57) ABSTRACT

An enterprise management system and an execution method thereof are provided. The enterprise management system includes a storage device, storing multiple modules, and a processor, coupled to the storage device and used to execute the modules. The processor obtains user operation behavior data and executes a data collection module according to the user operation behavior data to obtain user organization information, a user operation behavior record, and a user operation time record. The data collection module generates inference data according to the user organization information, the user operation behavior record, and the user operation time record. The processor executes a model inference module, and inputs the inference data to a task inference model in the model inference module, so that the task inference model generates inference result data. Optimized and/or personalized recommendation results of a system function, task, or operation sequence according to user operation behaviors are automatically provided.

### CROSS-REFERENCE TO RELATED APPLICATION

This application claims the priority benefit of China application serial no. 202111365202.2, filed on Nov. 17, 2021. The entirety of the above-mentioned patent application is hereby incorporated by reference herein and made a part of this specification.

### BACKGROUND

### Technical Field

The present disclosure relates to a process system, and in particular to an enterprise management system and an execution method thereof.

### Description of Related Art

At present, enterprise business behavior management is mostly realized by adopting a business process management (BPM) system. In this regard, the business process management system may be designed to be adapted for defining business processes between members of an organization and solutions of integration between constituent systems (for example, between people, between a person and an application system, and between application systems). However, in the face of an application scenario of a large amount of data, a traditional business process management system cannot effectively perceive data changes and immediately respond and process correctly. Also, since most of the processes in the system still rely on people to make decisions, knowledge of decision-making behaviors cannot be effectively encapsulated and replicated. Therefore, when the traditional business process management system faces the application scenario of a large amount of data, the business processes might not be carried out efficiently. More importantly, the user's operation habits and operation experience cannot be effectively replicated.

### SUMMARY

The present disclosure relates to an enterprise management system and an execution method thereof, which automatically provide optimized and/or personalized recommendation results of a system function, task, or operation sequence according to user operation behaviors.

According to an embodiment of the present disclosure, an enterprise management system of the present disclosure includes a storage device and a processor. The storage device stores a plurality of modules. The processor is coupled to the storage device and is used to execute the modules. The processor obtains user operation behavior data and executes a data collection module according to user operation behavior data to obtain user organization information, a user operation behavior record, and a user operation time record. The data collection module generates inference data according to the user organization information, the user operation behavior record, and the user operation time record. The processor executes a model inference module, and inputs the inference data to a task inference model in the model inference module, so that the task inference model generates inference result data.

According to an embodiment of the present disclosure, an execution method of an enterprise management system of the present disclosure includes the following. User operation behavior data are obtained. A data collection module is executed according to the user operation behavior data, so as to obtain user organization information, user operation behavior record, and user operation time record. Inference data are generated according to the user organization information, the user operation behavior record, and the user operation time record through the data collection module. A model inference module is executed, and the inference data are input into a task inference model in the model inference module. Inference result data are generated through the task inference model.

Based on the above, the enterprise management system and the execution method thereof of the present disclosure obtain the corresponding user organization information, user operation behavior record, and user operation time record as inference data according to user operation behavior data, and input the inference data into the pre-trained model inference module, so that the model inference module generates inference result data adapted for the current user or current application scenario according to the inference data.

To provide a further understanding of the above features and advantages of the disclosure, embodiments accompanied with drawings are described below in details.

### BRIEF DESCRIPTION OF THE DRAWINGS

FIG. 1 is a schematic diagram of an enterprise management system according to an embodiment of the present disclosure;

FIG. 2 is a flow chart of an execution method of an enterprise management system according to an embodiment of the present disclosure;

FIG. 3 is a schematic diagram of executing a plurality of modules of an enterprise management system according to an embodiment of the present disclosure;

FIG. 4 is a schematic diagram of an enterprise management system according to another embodiment of the present disclosure;

FIG. 5 is a training flow chart of the enterprise management system of FIG. 4 of the present disclosure;

FIG. 6 is an inference flow chart of the enterprise management system of FIG. 4 of the present disclosure.

### DESCRIPTION OF THE EMBODIMENTS

Now, reference will be made to the exemplary embodiment of the present disclosure in detail, and examples of the exemplary embodiment are illustrated in the accompanying drawings. Whenever possible, the same reference numerals are used in the drawings and descriptions to indicate the same or similar parts.

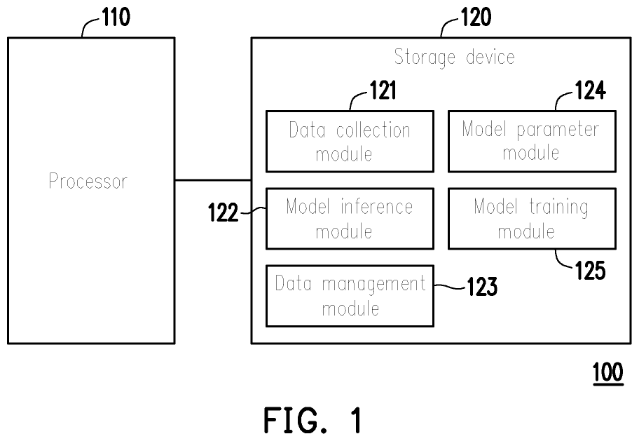

FIG. 1 is a schematic diagram of an enterprise management system according to an embodiment of the present disclosure. Referring to FIG. 1, an enterprise management system 100 includes a processor 110 and a storage device 120. The processor 110 is coupled to the storage device 120. In this embodiment, the processor 110 may include a processing circuit such as a central processor (CPU), a microprocessor control unit (MCU), or a field programmable gate array (FPGA), or a chip with data computing function, but the present disclosure is not limited thereto. The storage device 120 may be a memory, and the memory may be a non-volatile memory such as a read only memory (ROM) and an erasable programmable read only memory (EPROM), a volatile memory such as a random access memory (RAM), and a storage device such as a hard disc drive and a semiconductor memory, and the storage device 120 is used to store data including various programs and information mentioned in the present disclosure. In this embodiment, the storage device 120 may store a plurality of specific modules, algorithms, and/or software, etc., for the processor 110 to respectively read and execute. It is worth noting that the modules and units described in each embodiment of the present disclosure may respectively be implemented by one or more algorithms and/or software, and the related function and operation described in the embodiment may be implemented according to the execution result of one or more algorithms and/or software.

In this embodiment, the storage device 120 may store a data collection module 121, a model inference module 122, a data management module 123, a model parameter module 124, and a model training module 125. The processor 110 may read these modules stored in the storage device 120, and execute these modules to realize the function of automatically providing optimized and/or personalized recommendation results of a system function, task, or operation sequence according to user operation behaviors. In this embodiment, the enterprise management system 100 may be, for example, a computer host that is disposed in an enterprise, and may provide a user interface for the user to operate so as to obtain user operation behavior data. Or, in an embodiment, the enterprise management system 100 may also be implemented, for example, by the architecture of a cloud server system. The user may connect to the cloud server through executing the user interface (UI) program of an electronic appliance to perform related enterprise management operations. In this regard, the user may operate the content of the user interface displayed on the display screen of the electronic appliance, so that the user interface or related programs may provide corresponding user operation behavior data to the cloud server. The cloud server may execute the aforementioned modules to realize the function of providing optimized and/or personalized recommendation results of a system function, task, or operation sequence according to user operation behaviors.

In this embodiment, the data collection module 121 may be configured to collect user organization information, a user operation behavior record, a user operation time record, and related data information stored in an enterprise resource planning (ERP) database, to generate training data and inference data. In this embodiment, the model inference module 122 may be configured to input the inference data into a specific task inference model, and allow the specific task inference model to output optimized and/or personalized operation recommendation results.

The operation recommendation results may be, for example, but not limited to a system function recommendation, a user commonly used function recommendation, a best exception elimination solution recommendation, a user operation habit recommendation, etc. In this embodiment, the data management module 123 may be configured to clean, store, and update and maintain the multi-source training data information collected by the data collection module 121. In this embodiment, the model parameter module 124 may store one or more task inference models and the corresponding characteristic engineering parameters, respectively. In this embodiment, the model training module 125 may continuously learn through the iterative training of artificial intelligence machine learning algorithms, and gain insight into the user's operation experience from the data, and further save (store) the operation experience into the model parameter module 124 in the form of an artificial intelligence model.

In this embodiment, the user organization information is, for example, the user's corresponding authority, level, and/or related identity information in the enterprise organization architecture. The user operation behavior record may refer to the same or similar operation behavior record performed by the user in the past. The user operation time record may refer to the time when the user performed the same or similar operation behavior in the past.

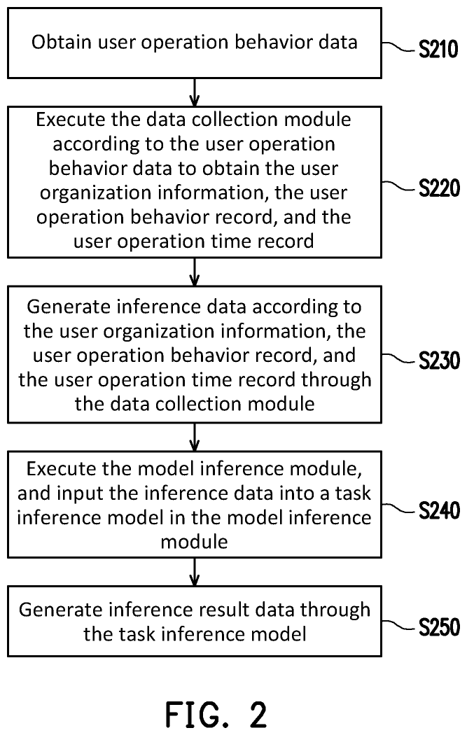

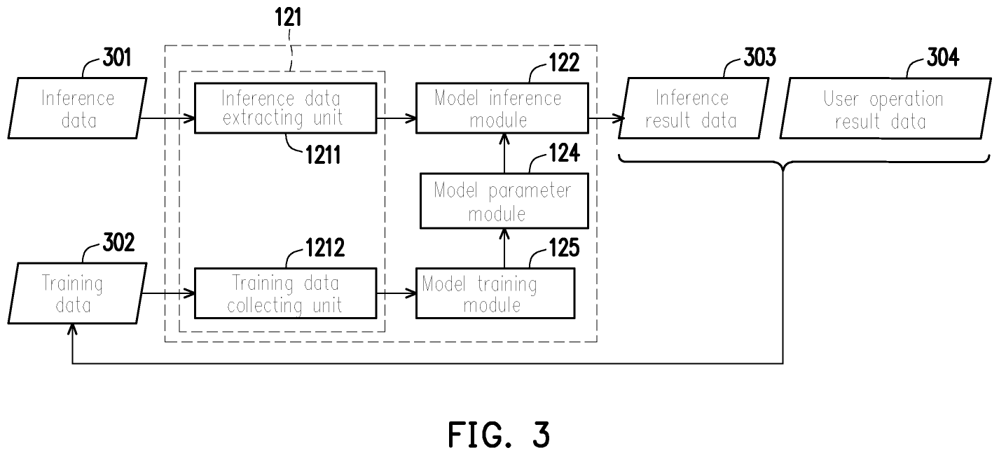

FIG. 2 is a flow chart of an execution method of an enterprise management system according to an embodiment of the present disclosure. FIG. 3 is a schematic diagram of executing a plurality of modules of an enterprise management system according to an embodiment of the present disclosure. Referring to FIGS. 1 to 3, the enterprise management system 100 may execute the following steps S210 to S250. In step S210, the processor 110 may obtain user operation behavior data. In this embodiment, the user may perform a relevant enterprise management operation behavior, for example, through an inputting apparatus (such as a mouse, a keyboard, or a touch screen, etc.) and/or an application programming interface (API) of the enterprise management system 100, so that the processor 110 may obtain the user operation behavior data corresponding to the user operation behavior. In step S220, the processor 110 may execute the data collection module 121 according to the user operation behavior data to obtain the user organization information, the user operation behavior record, and the user operation time record. In step S230, the processor 110 may generate inference data 301 according to the user organization information, the user operation behavior record, and the user operation time record through the data collection module 121.

In step S240, the processor 110 may execute the model inference module 122, and input the inference data 301 into a task inference model in the model inference module 122. As shown in FIG. 3, the data collection module 121 may include an inference data extracting unit 1211 and a training data collecting unit 1212. In this embodiment, the training data collecting unit 1212 may collect training data 302 through an enterprise resources planning database and/or a platform data management unit in advance, and provide the training data 302 to the model training module 125. The model training module 125 may iteratively train the task inference model according to different training data according to the training data 302.

Specifically, the inference data extracting unit 1211 may, for example, query the enterprise resources planning database and/or the platform data management unit according to the user operation behavior data, so as to obtain the user organization information, the user operation behavior record, and the user operation time record that may be used as the inference data 301, and the inference data extracting unit 1211 may perform data cleaning and data transformation on the extracted data, so as to input the appropriate inference data 301 to the model inference module 122. The model inference module 122 may select a corresponding one of a plurality of task inference models in the model parameter module 124 according to the inference data 301, and may input the inference data 301 into the task inference model selected by the model inference module 122. Therefore, in step S250, the processor 110 may generate inference result data 303 through the selected task inference model. The enterprise management system 100 of this embodiment may automatically generate the inference result data 303 adapted for the current user or the current application scenario according to the user operation behavior. In this embodiment, the processor 110 may perform engineering package transfer on the inference result data 303 to output a recommendation result list. The engineering package transfer may refer to, for example, transferring and/or arranging the data of a plurality of items of the inference result data 303 into a list according to a preset or specific list format. In this way, the user may decide and perform an appropriate next operation behavior according to the information and suggestions in the recommendation result list, so that the user may appropriately and correctly implement an enterprise management process.

In this embodiment, the enterprise management system 100 may further set an automatic scheduling program, and may record user operation result data 304 generated through an actual operation executed by the user according to the inference result data 303, so as to use the inference result data 303 and the user operation result data 304 as the next training data 302 to iteratively train the task inference model. In other words, the user may execute the same recommended information provided by the recommendation result list, or execute the same or different recommended information provided by the recommendation result list according to other considerations. In this regard, the enterprise management system 100 adaptively modifies and iteratively trains the task inference model, and may provide a personalized recommendation service.

It is worth noting that before executing the inference operation, the enterprise management system 100 may first collect relevant data information in an enterprise management software database to recommend the system to input. The data format of the aforementioned relevant data information may, for example, include but is not limited to supplier credit rating, supplier supply quality rating, and manufacturer consultation records, etc., and the aforementioned rating data may be continuous values or ordered discrete values. In addition, the enterprise management system 100 may construct user profile data according to user information and organization information. The enterprise management system 100 may record user operation behaviors, such as unstructured data such as business decision records and decision reasons, and may also record operation time information, such as operation start time and dwell time of the user under a certain function interface. Next, the training data collecting unit 1212 of the data collection module 121 may perform data collection, data cleaning, and data maintenance on the above multi-source information to update the enterprise resources planning database. The training data collecting unit 1212 may gain insight into the data characteristic information of the training data 302, and require the model training module 125 to perform model training. The model training module 125 may automatically select a suitable machine learning algorithm according to the data type of the training data 302 to construct characteristic engineering and an algorithm model structure. Finally, the model training module 125 may repeatedly train and test the model and optimize the model to obtain the task inference model with a current best parameter network. In this way, the enterprise management system 100 may provide artificial intelligence services in an enterprise management software system, and especially provide applications of personalized recommendation services.

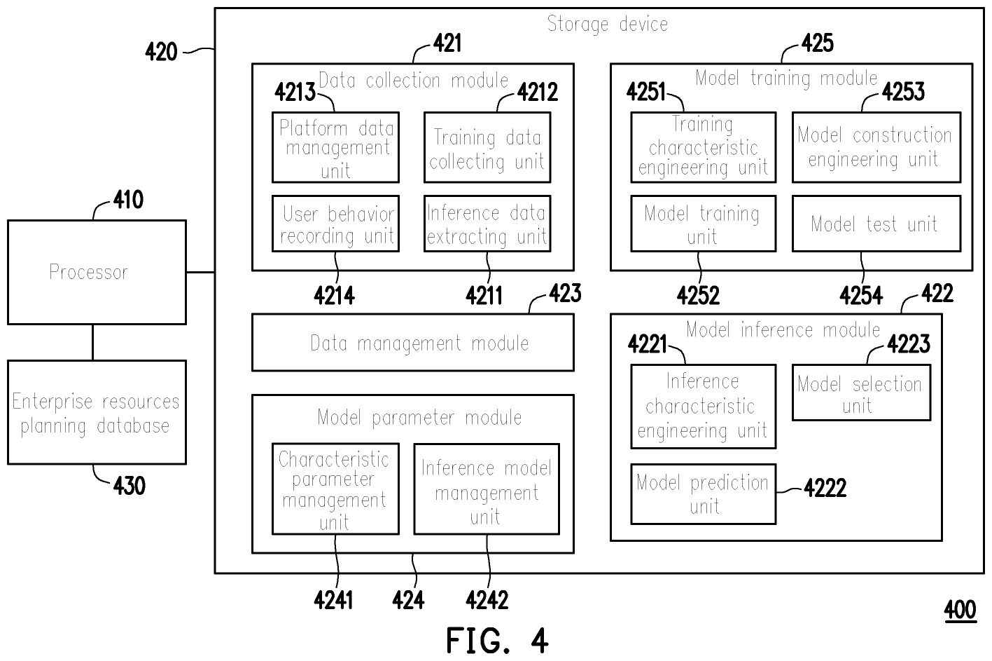

FIG. 4 is a schematic diagram of an enterprise management system according to another embodiment of the present disclosure. Referring to FIG. 4, an enterprise management system 400 may include a processor 410, a storage device 420, and an enterprise resources planning database 430. The processor 410 is coupled to the storage device 420 and the enterprise resources planning database 430. The storage device 420 may store a data collection module 421, a model inference module 422, a data management module 423, a model parameter module 424, and a model training module 425. In this embodiment, the enterprise resources planning database 430 may be stored in the storage device 420, or stored in another external storage device, and the present disclosure is not limited thereto. In this embodiment, the data collection module 421 may include an inference data extracting unit 4211, a training data collecting unit 4212, a platform data management unit 4213, and a user behavior recording unit 4214. The model inference module 422 may include an inference characteristic engineering unit 4221, a model prediction unit 4222, and a model selection unit 4223. The model parameter module 424 may include a characteristic parameter management unit 4241 and an inference model management unit 4242. The data training module 425 may include a training characteristic engineering unit 4251, a model training unit 4252, a model construction engineering unit 4253, and a model test unit 4254. The description of the above-mentioned embodiments of FIG. 1 to FIG. 3 may be referred to for the specific hardware features and implementation of the enterprise management system 400 of this embodiment.

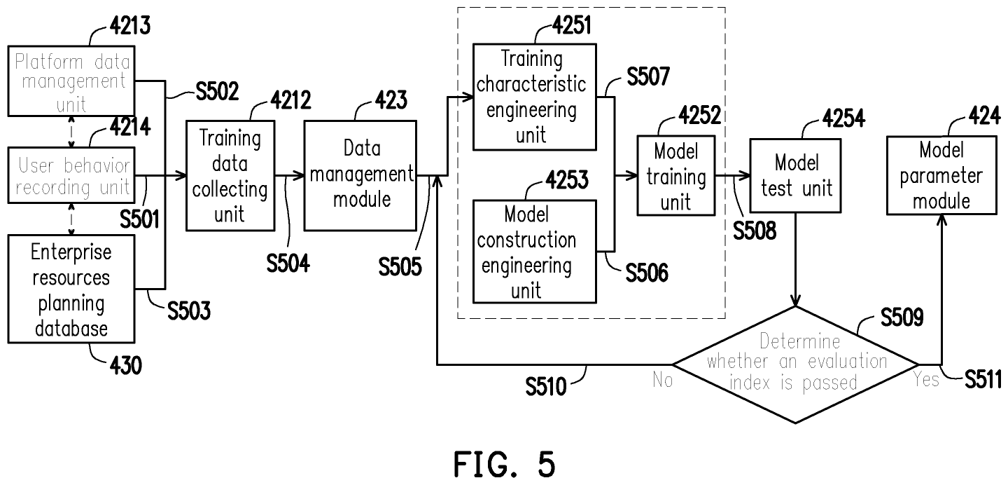

FIG. 5 is a training flow chart of the enterprise management system of FIG. 4 of the present disclosure. Referring to FIG. 4 and FIG. 5, the enterprise management system 400 may execute the following steps S501 to S511. In step S501, the processor 410 may execute the training data collecting unit 4212 to obtain the behavior attribute of the user and the data sample of the behavior target from the user behavior recording unit 4214. In step S502, the training data collecting unit 4212 may obtain the user information and organization data corresponding to the current operation behavior from the platform data management unit 4213 according to the data sample. In step S503, the training data collecting unit 4212 may obtain relevant information and records corresponding to the current operation behavior from the enterprise resources planning database 430 according to the data sample. In this embodiment, the training data collecting unit 4212 may use the data obtained in steps S501 to S503 as training data and perform storing, and the data may at least include the user organization information, the user operation behavior record, and the user operation time record. In step S504, the training data collecting unit 4212 may provide the training data to the data management module 423. In step S505, the processor 410 may execute the data management module 423 to perform data cleaning and regularization on the training data provided by the training data collecting unit 4212, and provide the training data after data cleaning and regularization to the training characteristic engineering unit 4251.

In step S506, the processor 410 may execute the model construction engineering 4253 to automatically select an appropriate algorithm according to the user's setting or according to the training data, so that the model training unit 4252 may perform a model network construction on the task inference model. In step S507, the processor 410 may execute the training characteristic engineering unit 4251 to generate the characteristic parameter according to the input requirements of the task inference model, and provide the characteristic parameter to the model training unit 4252. The processor 410 may execute the model training unit 4252 to train the task inference model according to the characteristic parameter. In step S508, the model training unit 4252 may provide the trained task inference model to the model test unit 4254. In step S509, the model test unit 4254 may determine whether the task inference model has completed training according to an evaluation index of the task inference model on the test set. If not, in step S510, the processor 410 may re-execute steps S505 to S509 to cycle through the training process; and if so, in step S511, the model training unit 4252 may output the task inference model and the corresponding characteristic parameter to the inference model management unit 4242 and the characteristic parameter management unit 4241 of the model parameter module 424 to save the model and the parameter.

It is worth noting that the model test unit 4254 may perform determining according to the evaluation index of the task inference model on the test set, and the evaluation index may be determined according to different task types, and may be, for example, classification accuracy, regression analysis mean square error, or area under the curve of receiver operating characteristic (ROC) curve. In addition, the model training module 425 may iteratively execute the training characteristic engineering unit 4251, the model training unit 4252, and the model construction engineering unit 4253 to iteratively train the task inference model.

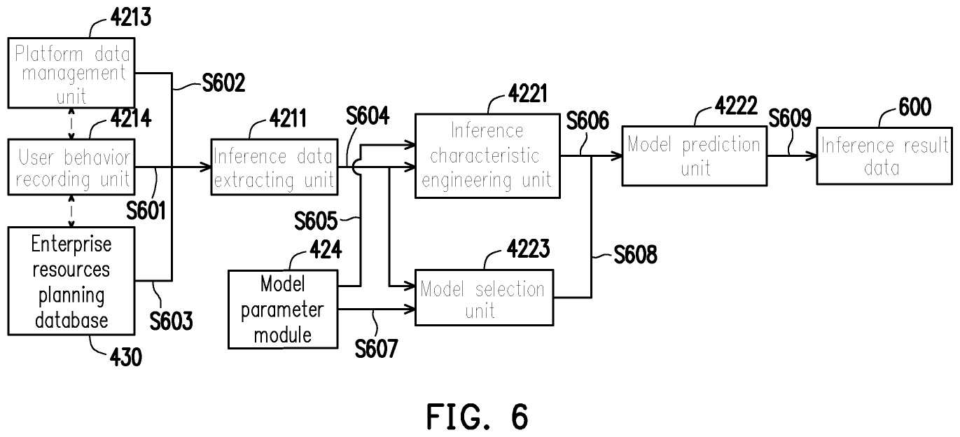

FIG. 6 is an inference flow chart of the enterprise management system of FIG. 4 of the present disclosure. Referring to FIG. 4 and FIG. 6, the enterprise management system 400 may execute the following steps S601 to S609. In step S601, the processor 410 may transmit user current behavior attribute data to the inference data extracting unit 4211 through the user behavior recording unit 4214 according to the user operation behavior data. In step S602 and step S603, the processor 410 may execute the inference data extracting unit 4211 to extract the user organization information, the user operation behavior record, and the user operation time record from the platform data management unit 4213 and the enterprise resources planning database 430. In step S604, the processor 410 may execute the inference data extracting unit 4211 to provide the user organization information, the user operation behavior record, and the user operation time record to the inference characteristic engineering unit 4221 of the model inference module 422. In step S605, the processor 410 may execute the inference characteristic engineering unit 4221 to obtain corresponding characteristic engineering parameters from the characteristic parameter management unit 4241 of the model parameter module 424 according to the user organization information, the user operation behavior record, and the user operation time record, and perform characteristic extraction on the user organization information, the user operation behavior record, and the user operation time record to generate inference data according to the characteristic engineering parameters. In step S606, the inference characteristic engineering unit 4221 provides the inference data to the model prediction unit 4222 and the model selection unit 4223. In step S607, the processor 410 may execute the model selection unit 4223 to select one of a plurality of models stored in the inference model management unit 4242 of the model parameter module 424 as the task inference model according to the inference data. The model selection unit 4223 may provide the model network data of the task inference model to the model prediction unit 4222. In step S608, the processor 410 may execute the model prediction unit 4222 to input the inference data to the task inference model, so that the task inference model performs inference calculation according to the inference data. In step S609, the model prediction unit 4222 may generate inference result data 600. In this embodiment, the processor 410 may further perform engineering package transfer on the inference result data 600 to output a recommendation result list.

In summary, the enterprise management system and the execution method thereof of the present disclosure may collect and analyze user information, user operation behavior, and operation time, and infer the user's operation habits through the artificial intelligence model, and realize system functions and personalized recommendation functions of tasks and operation sequence. The enterprise management system of the present disclosure may recommend common functions according to the user's role and organization information, so as to effectively reduce the user's learning threshold and enterprise employee training costs. The enterprise management system of the present disclosure may collect user's choices and judgments in the event of decision-making, and perform operation behavior classification and analysis to achieve the optimal operation recommendation for the enterprise system in decision-making scenarios.

Lastly, it is to be noted that: the embodiments described above are only used to illustrate the technical solutions of the disclosure, and not to limit the disclosure; although the disclosure is described in detail with reference to the embodiments, those skilled in the art should understand: it is still possible to modify the technical solutions recorded in the embodiments, or to equivalently replace some or all of the technical features; the modifications or replacements do not cause the essence of the corresponding technical solutions to deviate from the scope of the technical solutions of the embodiments.

What is claimed is:

1. An enterprise management system, comprising:
a storage device, storing a plurality of modules; and
a processor, coupled to the storage device, used to execute the modules;
wherein the processor obtains user operation behavior data, and executes a data collection module according to the user operation behavior data to obtain user organization information, a user operation behavior record, and a user operation time record, wherein the data collection module generates inference data according to the user organization information, the user operation behavior record, and the user operation time record; and
the processor executes a model inference module, and inputs the inference data to a task inference model in the model inference module, so that the task inference model generates inference result data.

2. The enterprise management system according to claim 1, wherein the data collection module comprises a user behavior recording unit, a platform data management unit, and an inference data extracting unit, and the user behavior recording unit transmits user current behavior attribute data to the inference data extracting unit according to the user operation behavior data, so that the inference data extracting unit extracts the user organization information, the user operation behavior record, and the user operation time record from the platform data management unit and an enterprise resources planning database, and provides the user organization information, the user operation behavior record, and the user operation time record to the model inference module.

3. The enterprise management system according to claim 2, wherein the model inference module comprises an inference characteristic engineering unit, a model selection unit, and a model prediction unit, and the inference characteristic engineering unit obtains a corresponding characteristic engineering parameter from a model parameter module according to the user organization information, the user operation behavior record and the user operation time record, and performs characteristic extraction on the user organization information, the user operation behavior record, and the user operation time record according to the characteristic engineering parameter to generate the inference data,
wherein the model selection unit selects one of a plurality of models as the task inference model according to the inference data, and the model prediction unit inputs the inference data to the task inference model, so that the task inference model generates the inference result data.

4. The enterprise management system according to claim 1, wherein the processor performs engineering package transfer on the inference result data to output a recommendation result list.

5. The enterprise management system according to claim 1, wherein the processor executes a model training module according to an automatic scheduling setting to train the task inference model according to the inference result data and user operation result data corresponding to the inference result data.

6. The enterprise management system according to claim 1, wherein the data collection module comprises a training data collecting unit, the training data collecting unit obtains training data from an enterprise resources planning database, and the processor executes a data training module according to the training data to train the task inference model, wherein the processor stores a characteristic engineering parameter of the task inference model after training in a model parameter module.

7. The enterprise management system according to claim 6, wherein the data training module comprises a training characteristic engineering unit, a model construction engineering unit, and a model training unit, the training characteristic engineering unit performs data exploration on the training data, and the model construction engineering unit constructs the task inference model according to the training data,
wherein the training characteristic engineering unit generates a characteristic parameter according to an input requirement of the task inference model, and the model training unit trains the task inference model according to the characteristic parameter.

8. The enterprise management system according to claim 7, wherein the data training module further comprises a model test unit, the model test unit iteratively executes the training characteristic engineering unit, the model construction engineering unit, and the model training unit model to iteratively train the task inference model.

9. The enterprise management system according to claim 8, wherein the model test unit determines whether the task inference model has completed training according to an evaluation index of the task inference model on a test set.

10. The enterprise management system according to claim 7, wherein the processor executes a data management module to perform data cleaning and regularization on the training data, and provides the training data after the data cleaning and regularization to the training characteristic engineering unit.

11. An execution method of an enterprise management system, comprising:
obtaining user operation behavior data;
executing a data collection module according to the user operation behavior data, so as to obtain user organization information, user operation behavior record, and user operation time record;
generating inference data according to the user organization information, the user operation behavior record, and the user operation time record through the data collection module;
executing a model inference module, and inputting the inference data into a task inference model in the model inference module; and
generating inference result data through the task inference model.

12. The execution method of an enterprise management system according to claim 11, wherein generating the inference data according to the user organization information, the user operation behavior record, and the user operation time record through the data collection module comprises:
transmitting user current behavior attribute data to an inference data extracting unit through a user behavior recording unit according to the user operation behavior data,; and
extracting the user organization information, the user operation behavior record, and the user operation time record from a platform data management unit and an enterprise resources planning database through the inference data extracting unit, and providing the user organization information, the user operation behavior record, and the user operation time record to the model inference module.

13. The execution method of an enterprise management system according to claim 12, wherein generating the inference result data through the task inference model comprises:
obtaining a corresponding characteristic engineering parameter from a model parameter module through an inference characteristic engineering unit according to the user organization information, the user operation behavior record, and the user operation time record, and performing characteristic extraction on the user organization information, the user operation behavior record, and the user operation time record according to the characteristic engineering parameter to generate the inference data;
selecting one of a plurality of models as the task inference model according to the inference data through a model selection unit; and
inputting the inference data to the task inference model through a model prediction unit, so that the task inference model generates the inference result data.

14. The execution method of an enterprise management system according to claim 11, further comprising:
performing engineering package transfer on the inference result data to output a recommendation result list.

15. The execution method of an enterprise management system according to claim 11, further comprising:
executing a model training module according to an automatic scheduling setting, so as to train the task inference model according to the inference result data and user operation result data corresponding to the inference result data.

16. The execution method of an enterprise management system according to claim 11, further comprising:
obtaining training data from an enterprise resources planning database through a training data collecting unit;
executing a data training module according to the training data to train the task inference model; and
storing a characteristic engineering parameter of the task inference model after training in a model parameter module.

17. The execution method of an enterprise management system according to claim 16, wherein training the task inference model comprises:
performs data exploration on the training data through a training characteristic engineering unit;
constructing the task inference model according to the training data through a model construction engineering unit;
generating a characteristic parameter according to an input requirement of the task inference model through the training characteristic engineering unit; and
training the task inference model according to the characteristic parameter through a model training unit.

18. The execution method of an enterprise management system according to claim 17, further comprising:
iteratively executing the training characteristic engineering unit, the model construction engineering unit, and the model training unit model through a model test unit to iteratively train the task inference model.

19. The execution method of an enterprise management system according to claim 18, further comprising:
determining whether the task inference model has completed training according to an evaluation index of the task inference model on a test set through the model test unit.

20. The execution method of an enterprise management system according to claim 17, further comprising:
executing a data management module to perform data cleaning and regularization on the training data; and
providing the training data after data cleaning and regularization to the training characteristic engineering unit.
